(19) United States
(12) Patent Application Publication
(10) Pub. No.: US 2016/0368122 A1
(43) Pub. Date: Dec. 22, 2016

(54) Socket wrench

(71) Applicant: Kuo Lung Chen, Nantou (TW)

(72) Inventor: Kuo Lung Chen, Nantou (TW)

(21) Appl. No.: 15/249,502

(22) Filed: Aug. 29, 2016

(51) Int. Cl. B25B 13/46; B25B 13/48

(52) U.S. Cl. CPC B25B 13/463; B25B 13/48

(57) ABSTRACT

A socket wrench includes a handle having a ratchet end including a circular opening having a groove in a C-shaped top rim, and an inward extending bottom rim; and a space on a wall of the opening, a convex top shoulder having two ends connected to two ends of the groove respectively; a socket in the opening and including outer ratchet teeth and inner rotation drive teeth; a pawl in the space and including a first member having teeth meshing the ratchet teeth, a second member having a crescent top cover covering the first member, and a spring biased between the first member and the second member; and a retaining ring in the groove.

### BACKGROUND OF THE INVENTION

1. Field of the Invention

The invention relates to wrenches and more particularly to a socket wrench enabling an easy repair and replacement of the components.

2. Description of Related Art

A socket wrench is a type of wrench having a socket attached at one end, usually used to turn a fastener. The most prevalent form is the ratcheting socket wrench.

However, repair and components replacement of the conventional socket wrenches are difficult.

Thus, the need for improvement still exists.

### SUMMARY OF THE INVENTION

It is therefore one object of the invention to provide a socket wrench comprising a handle having an end and a ratchet end comprising a circular opening having a C-shaped top rim, a C-shaped groove in the top rim, and an inward extending bottom rim; and a space on a wall of the opening and adjacent to the handle, a convex shoulder on a top edge of the space and having two ends connected to two ends of the groove respectively; a cylindrical socket disposed in the opening and on the bottom rim, the socket comprising ratchet teeth on an outer surface and rotation drive teeth on an inner surface; a pawl disposed in the space and comprising a first member having teeth meshing the ratchet teeth, a second member having a crescent top cover covering the first member, and a spring biased between the first member and the second member; and a retaining ring disposed in the groove and comprising a C-shaped member having two ends on the first and second members respectively, and two holes through both ends respectively.

The above and other objects, features and advantages of the invention will become apparent from the following detailed description taken with the accompanying drawings.

### BRIEF DESCRIPTION OF THE DRAWINGS

FIG. 1 is a perspective view of a socket wrench of a first preferred embodiment of the invention;

FIG. 2 is a view similar to FIG. 1 with the retaining ring detached;

FIG. 3 is an exploded view of the socket wrench;

FIG. 4 is a perspective view of a socket wrench of a second preferred embodiment of the invention;

FIG. 5 is a view similar to FIG. 4 with the retaining ring detached; and

FIG. 6 is an exploded view of the socket wrench of FIG. 4.

### DETAILED DESCRIPTION OF THE INVENTION

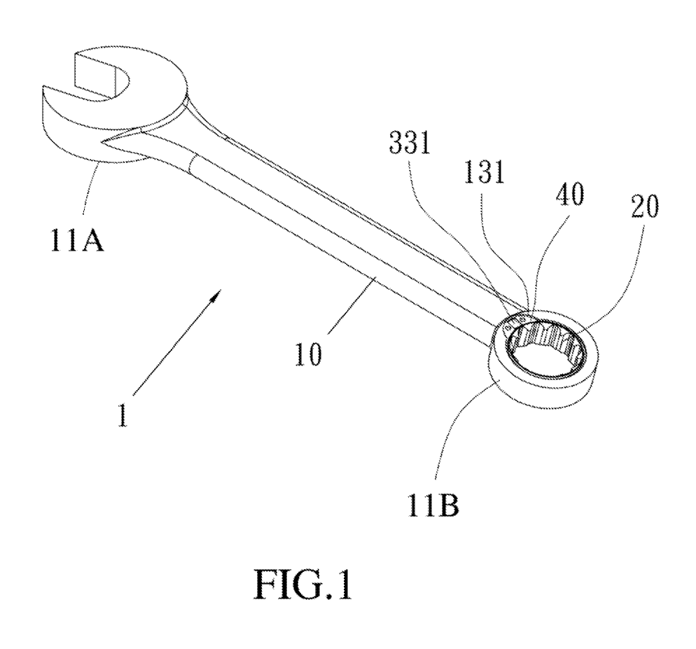

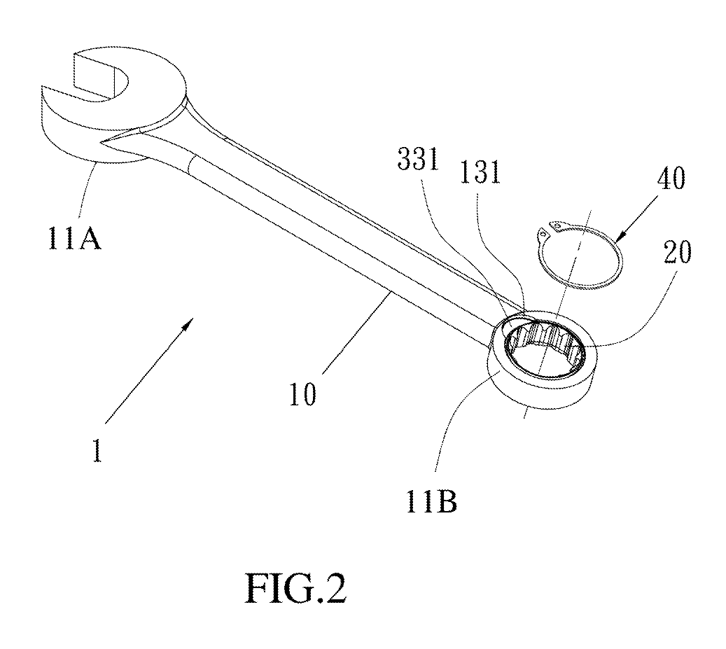

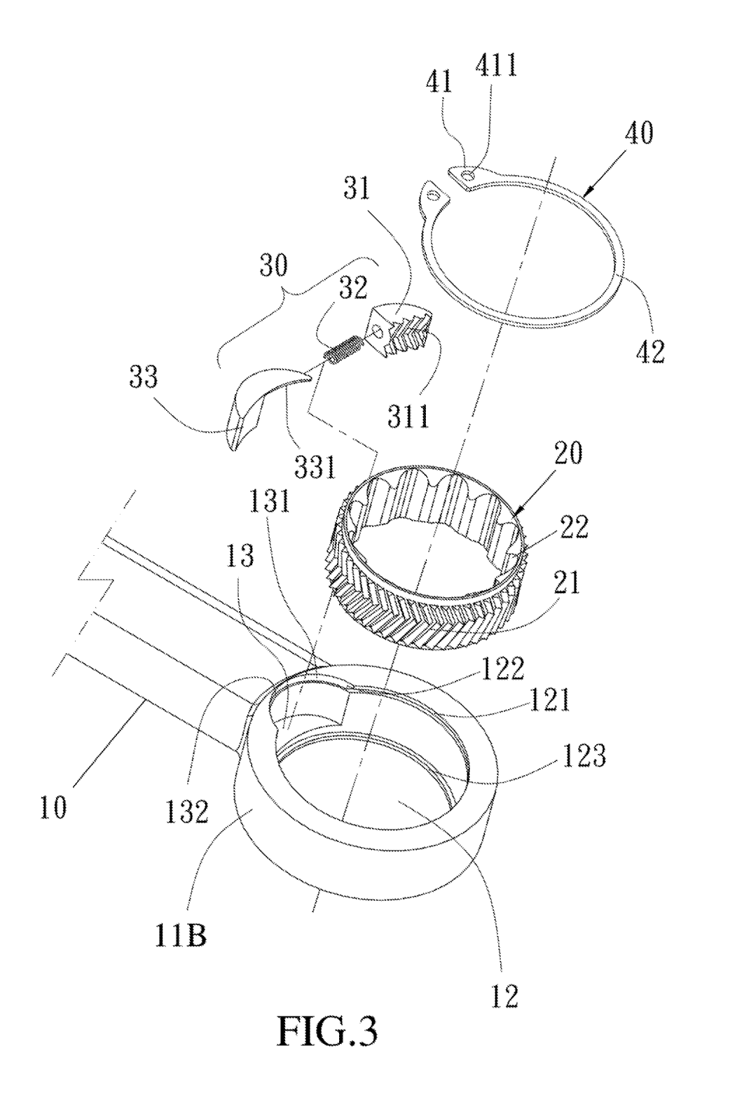

Referring to FIGS. 1 to 3, a socket wrench 1 of a first preferred embodiment of the invention comprises a handle 10 having an end 11A and a ratchet end 11B. The ratchet end 11B comprises a circular opening 12 having a C-shaped top rim 121, a C-shaped groove 122 in the top rim 121, and an inward extending bottom rim 123; and a space 13 on a wall of the opening 12 and adjacent to the handle 10, a shoulder 132 on a convex top edge 131 and having two ends connected to two ends of the groove 122 respectively.

A cylindrical socket 20 comprises ratchet teeth 21 on an outer surface and rotation drive teeth 22 on an inner surface. The socket 20 is disposed in the opening 12 and on the bottom rim 123. A pawl 30 is disposed in the space 13 and comprises a first member 31 having teeth 311 meshing the ratchet teeth 21, a second member 33 having a crescent top cover 331 covering the first member 31, and a spring 32 biased between the first member 31 and the second member 33. A retaining ring 40 is disposed in the groove 122 and comprises a C-shaped member 42 having two ends 41 on the first and second members 31 and 32 respectively, and two holes 411 through both ends 41 respectively.

It is envisaged by the invention that an easy repair and replacement of the components is made possible.

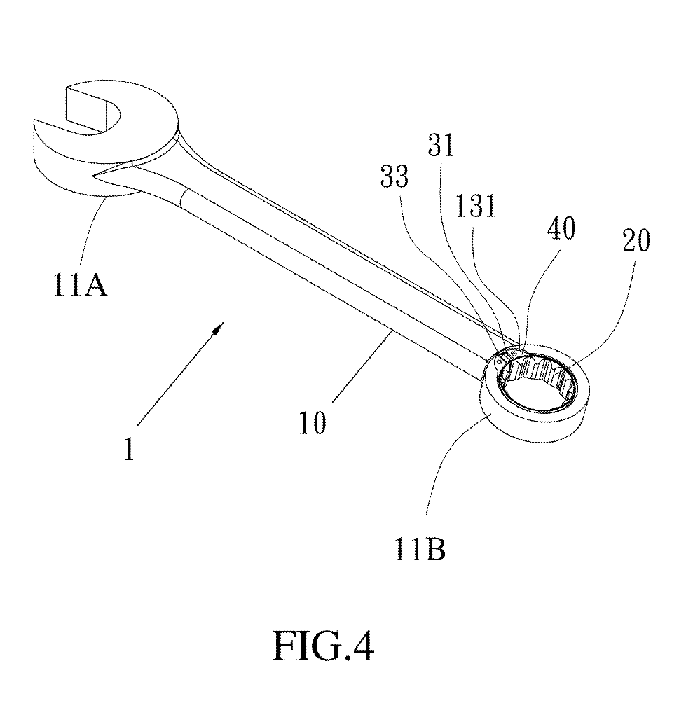

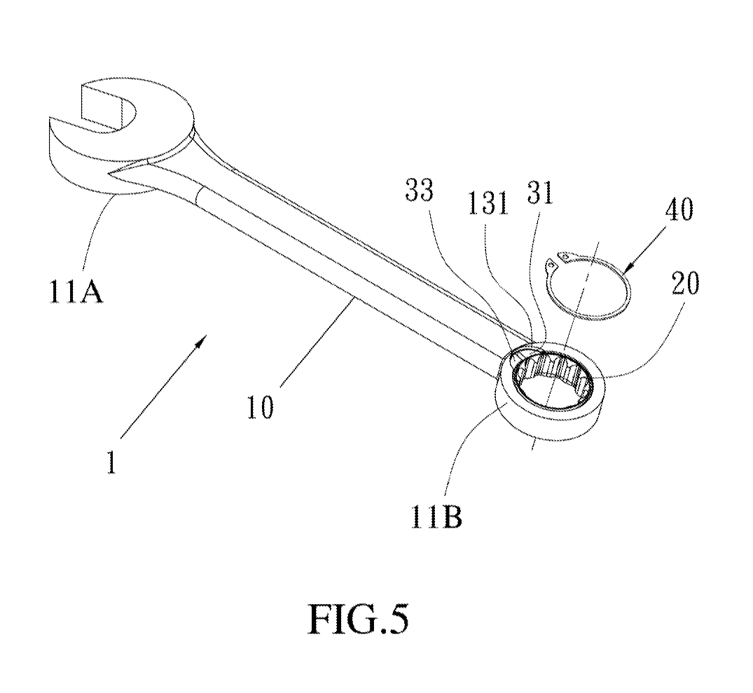

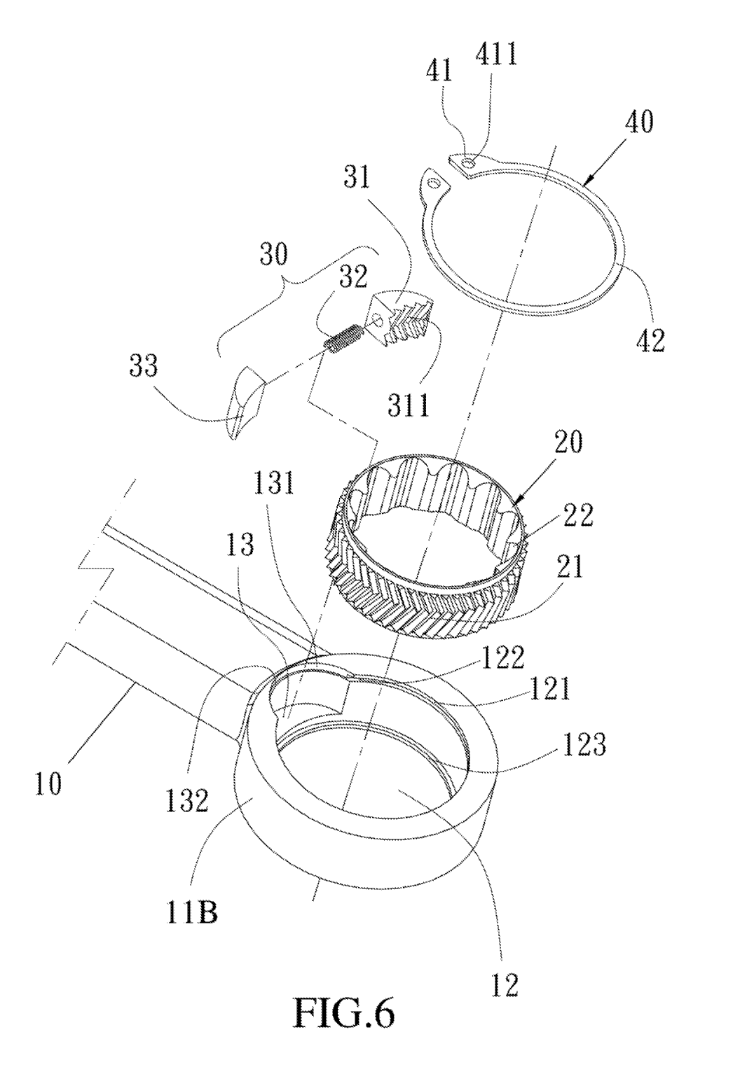

Referring to FIGS. 4 to 6, a socket wrench 1 of a second preferred embodiment of the invention is shown. The characteristic of the second preferred embodiment is the elimination of the top cover.

While the invention has been described in terms of preferred embodiments, those skilled in the art will recognize that the invention can be practiced with modifications within the spirit and scope of the appended claims.

What is claimed is:

1. A socket wrench comprising:
a handle having an end and a ratchet end including a circular opening having a C-shaped top rim, a C-shaped groove in the top rim, and an inward extending bottom rim; and a space on a wall of the opening and adjacent to the handle, a convex shoulder on a top edge of the space and having two ends connected to two ends of the groove respectively;
a cylindrical socket disposed in the opening and on the bottom rim, the socket including a plurality of ratchet teeth on an outer surface and a plurality of rotation drive teeth on an inner surface;
a pawl disposed in the space and including a first member having teeth meshing the ratchet teeth, a second member having a crescent top cover covering the first member, and a biasing member biased between the first member and the second member; and
a retaining ring disposed in the groove and including a C-shaped member having two ends on the first and second members, respectively, and two holes through both ends respectively.
